(19) United States
(12) Patent Application Publication
(10) Pub. No.: US 2007/0011606 A1
(43) Pub. Date: Jan. 11, 2007

(54) Comment field inclusion with an order collaboration form

(76) Inventor: Ramin Bagheri, Schwetzingen (DE)

Correspondence Address: KENYON & KENYON LLP, ONE BROADWAY, NEW YORK, NY, 10004, US

(21) Appl. No.: 11/175,556

(22) Filed: Jul. 5, 2005

(51) Int. Cl. G06F 17/21

(52) U.S. Cl. 715/517

(57) ABSTRACT

Order collaboration forms include encoding providing comment fields associated with individual term fields. The comment fields are provided in secondary displays, typically in a floating window display. The window is activated based on the location of a position indicator, such as a cursor or a highlight window. In the floating window, the comment field is therein visible. In one embodiment, when the position indicator is relative to a data field, the comment field becomes visible. A comment field indicator may used to provide the user with a directly visible indicator of whether a data field has a comment field, as the comment field is not directly visible until activated. Furthermore, in response to a user input command, the comment field becomes an active input field allowing a user to directly input comments specifically associated and physically designated with the individual term field.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to order processing and more specifically to including comment fields with terms in order forms.

In existing order collaboration systems, the electronic documents provide a readily visible and usable display of order terms. Previously with physical documents, comments could be written directly onto the documents. While the current documents streamline order processing, there still are times when parties wish to add comments or other information to be associated with a particular field.

A current solution is the insertion of a general comment field within the electronic document. This field is generally an undeclared field allowing for data entry and is located at the end of the electronic document. This field allows a party to type in comments associated with various elements of the form. Although, this field is not associated with any specific data field in the form.

In order to provide specific comments for a particular field, the user must enter a comment in the general field and then enter a reference indicator to associate the comment with a particular term. For example, an order form may have fields indicating the parties to the contract, the items ordered, delivery conditions, financial elements and other contract terms. If a user wishes to add a comment regarding a delivery condition, the user must enter the comment in the general comment field. The user must then provide an indication that the comment refers to the delivery condition, such as a precursor stating that “with respect to the delivery conditions . . . . ”

This current approach may be problematic. For example, there is a disconnect between the comment field and the element upon which the comment is directed. This disparity allows for the potential to miss the comment by accidentally overlooking the comment field. Based the general nature of the comment field, a party may also fail to properly identify which element the comments refers to, or a user reading the comment may misinterpret which element the comment is applicable to.

As generally known, the comment field is a basic data entry field. This may be problematic with multiple users providing multiple comments. Like the general comments noted above, with multiple users, each user must therefore identify their comments, including the user's identification, date, time, and other information. These static fields may be problematic when issues arise from identification of who entered the comments.

There currently exist comment overlay features associated with a word processing application. For example, in the word processing application, an overlay window may be used to display comments when a cursor is positioned relative to a highlighted text portion. This overlay window may also be used for the display of footnotes or endnotes, allowing a person to see the comments without having to scroll to the bottom of the page. This feature typically uses a notation included with the normal text, such as a subscript or a superscript number, similar to notations found in printed documents to indicate a footnote or an endnote.

Another example of overlay technology includes hyperlinks having descriptions fields. When a position indicator, such as a cursor, is over the active hyperlink, a pop-up window displays the associated information to provide a user more information on the active link.

These existing technologies provide a visual display of previously entered information in a static document. The word processing application uses the comment field to display previously entered comments in a full document, such as footnotes for a report or a reviewers comments of a passage in a document. The documents having the comment fields associated therewith are word processing documents, or with hyperlinks, mark-up language encoded files being read by a browser application. Existing technologies do not provide for comment fields in active form documents associated with a database.

Existing technologies also limit the display comment field based on existing input data. For example, comments in the word processing document display previously entered comments. Existing technologies do not provide for interactive comment fields allowing for direct user input into term-specific comment fields.

### BRIEF DESCRIPTION OF THE DRAWINGS

FIG. 1 illustrates a block diagram of one embodiment of an apparatus allowing for the inclusion of a comment field in an order collaboration form.

FIGS. 2-4 illustrate representative screenshots of varying embodiments of order collaboration forms having the comment field therein.

FIG. 5 illustrates the steps of one embodiment of a method for the inclusion of a comment field in an order collaboration form.

FIG. 6 illustrates the steps of another embodiment of a method for the inclusion of a comment field in an order collaboration form.

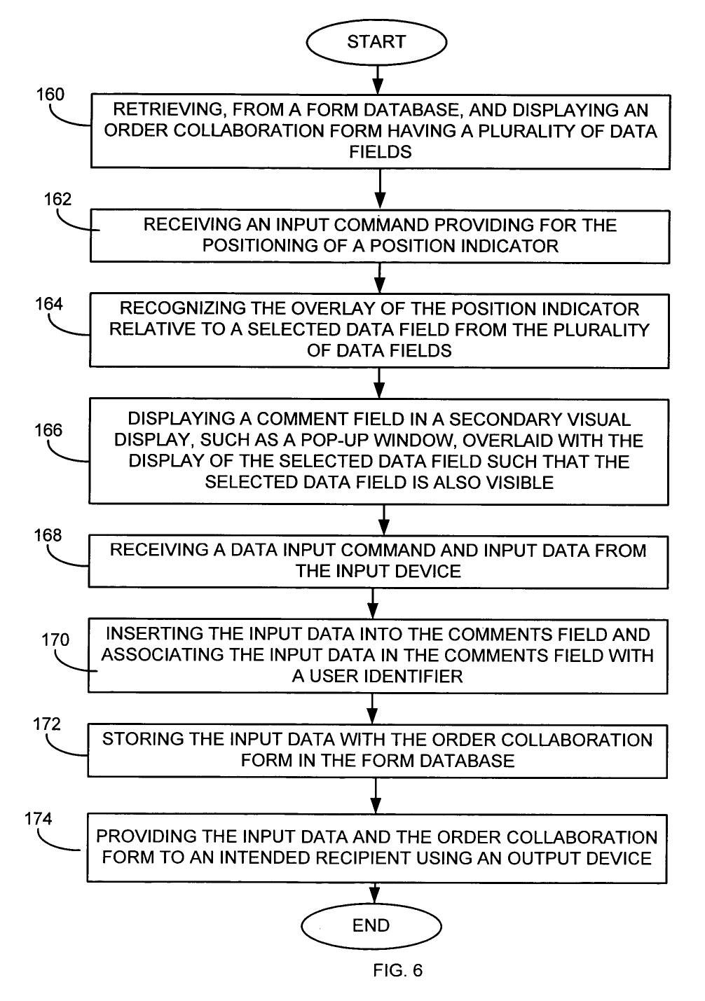

### DETAILED DESCRIPTION

With electronic order collaboration forms, the forms include encoding providing comment fields associated with individual term fields. The form is displayed with the form itself and one or more business objects inserted into corresponding data fields. The comment fields are provided in secondary displays, typically in a floating window display. The window is activated based on the location of a position indicator, such as a cursor or a highlight element. The comment field is visible in the floating window. For example, in one embodiment when the position indicator is relative to a data field, the comment field becomes visible. Where the data field does not include comments, a comment field is not displayed. In one embodiment, a comment field indicator may be used to provide the user with a directly visible indication of whether a data field has a comment field, as the comment field is not directly visible until activated.

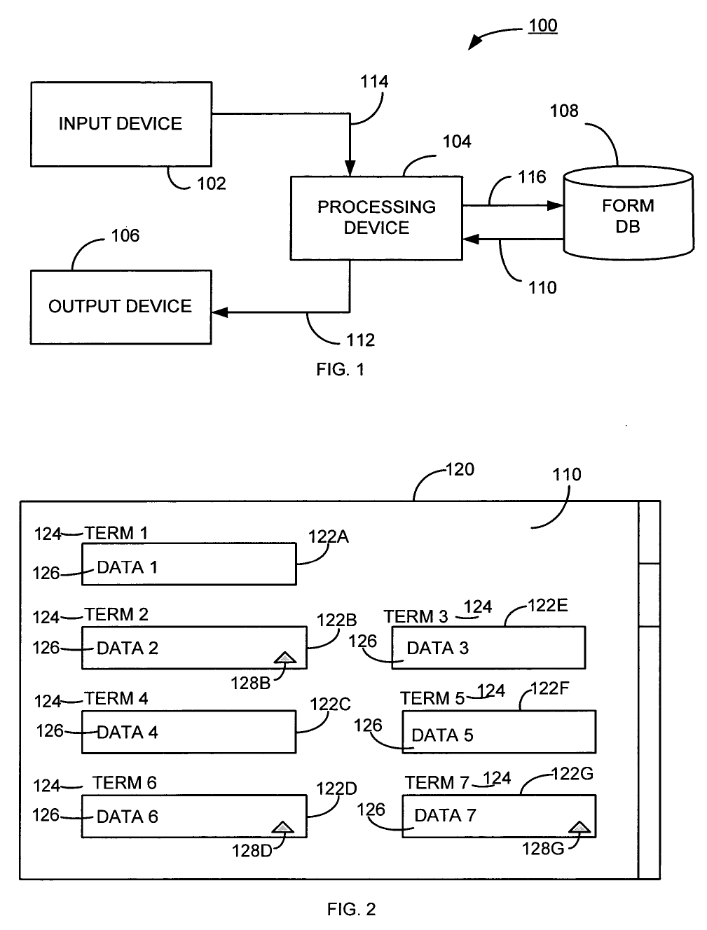

FIG. 1 illustrates an apparatus 100 providing for the inclusion of comment fields to an order collaboration form. The apparatus 100 includes an input device 102, a processing device 104, an output device 106 and a form database 108.

The form database 108, such as a database associated with a supplier relationship management database, provides one or more forms 110 to the processing device 104. Further stored in the form database 108 are business objects, which include data that is populated into the form. The processing device 104, operating in response to executable instructions, converts the form 110 into a visible format and provides a visible output form 112 to the output device 106, such a video display. In one embodiment, the form 110 is assembled by matching and combining the form template with the associated business objects disposed in corresponding data fields.

Included within the visible form 110 is the data from the business object associated with the data entry fields. Also included in the form 110 is a second layer of data of specific comment fields associated with the data entry fields, which is also provided from the associated business object. In the executable instructions of the processing device 104, the second layer of data is provided in a secondary visual display, such as a pop-up window, so that the processing device provides the secondary visual display in response to input queues. This secondary data may be retrieved from the same business object that includes the visible data in the form 110.

Illustrated in FIG. 1, the input device 102 is operative to receive input and generate input commands 114, which may be indicative of the positioning of a position indicator on the output device 106. For example, the position indicator, as described in further detail below, may be a cursor visible on the output device 106 and the input command 114 is the movement of a mouse or other positioning device. The processing device 104 receives the input commands 114 and when the input command 114 indicates the position indicator relative to a data field having comments associated therewith, the processing device 104 generates the visible output form 112 including the secondary visual display with the comment field.

The apparatus of FIG. 1 further allows for the inputting of comments into the comment field through the input device 102. For example, if the input device 102 is a keyboard, typed input may be inserted into the comment field. In one embodiment, the comments are associated with the user entering the information. As discussed in further detail below, the insertion of new comments into the form may be performed in conjunction with viewing the comment fields. Although, when new comments have been entered, the processing device 104 is operative to store the updated forms 116 back to the form database 108, including storing the comments in the associated business objects. In accordance with known database technology, the database 108 is accessible by any suitable number of processing devices, such as device 104, through any suitable number of access points in allowing for multi-party access to the forms 110 and the data therein.

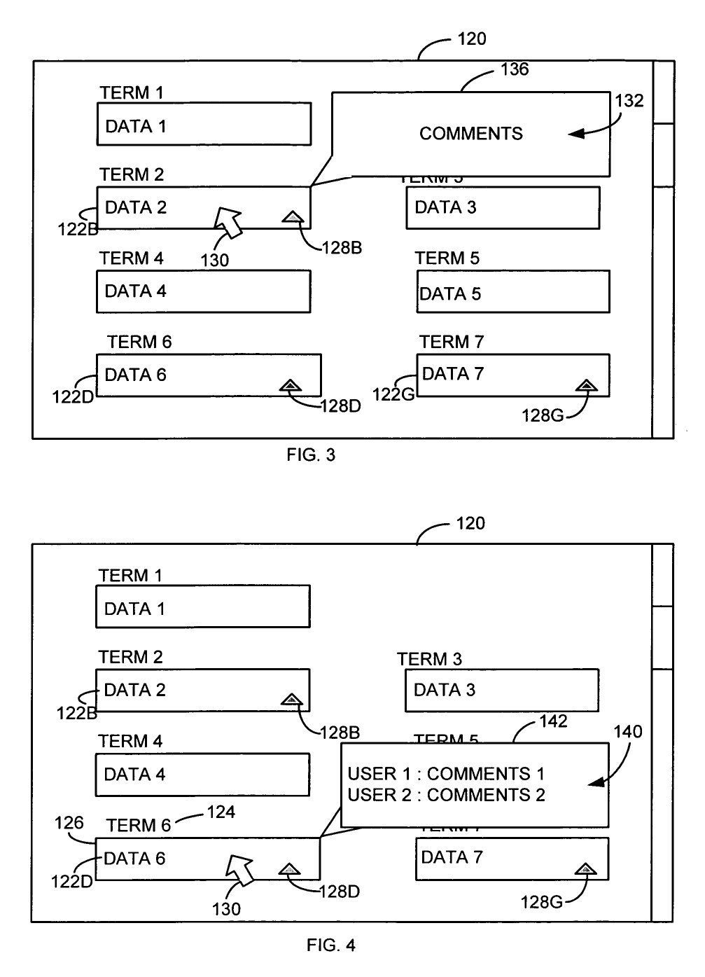

FIG. 2 illustrates a representative display 120 of an exemplary form 110 from the database 108 as displayed on the output device 106 of FIG. 1. Included with the form 110 are multiple data fields 122A-122G. Each of the data fields 122A-122G includes term headers 124 and data 126. The headers 124 and data 126 are illustrated generally using generic terms, but in accordance with known form technology, the terms represent any of the varying arrays of contract terms, including parties, items, prices, delivery terms, quantity, quality terms, etc. It is also recognized that the headers 124 describes the various terms and the data 126 represents the specific elements as either suggested by a party to the agreement or agreed to by both parties, provided from different business objects.

FIG. 2 also illustrates comment identifiers 128B, 128D and 128G, as visible in data fields 122B, 122B and 122G. In the exemplary embodiment of FIG. 2, the comment identifiers are geometric designs adjacent to the data 126, such as offset or right-justified within the data fields 122.

FIG. 2 illustrates one embodiment of the display 120 retrieved from the form database 108 of FIG. 1. In the display 120 of FIG. 2, this display may represent an initial display of the form 110 as initially retrieved from the database 108 of FIG. 1. For example, if a first party entered the form terms 122 and stored the form in the database 108 and another party retrieves the form 110, the display 120 provides a visual indication of a general agreement or an offer for an agreement and an indication that the requesting party included additional comments. As noted above, in prior approaches, the form may include a generic field at the bottom of the form with all comments grouped into this location and no specific direction indication in the data field that there were comments associated therewith.

FIG. 3 illustrates the display 120 including a position indicator 130. The position indicator 130 is controlled in response to input commands 114 generated by the input device 102, as illustrated in FIG. 1. In the embodiment of FIG. 3, the position indicator is a floating arrow display, but may also be a cursor or highlighted field controllable by a keystroke, shift keys or other suitable input commands 114. When the position indicator 130 is relative to the data field 122 and the data field 122 includes a comment field 132, herein as indicated by the comment field indicators 128, the comment field 132 is made visible in a secondary display 136.

Illustrated in FIG. 3, the secondary visual display 136 is a pop-up window that is overlaid with the display of the selected data field 122B. This overlaid display allows a user to view both the data field 122 and the comment field 132. In another embodiment, the secondary visual display 136 may be offset from the display 120, such as in a secondary window outside of the display 120. It is also noted that in the exemplary display 120, there exists two other additional comment fields, not visible because the position indicator 130 is not relative to the fields 122D and 122G. Whereas, if the position indicator 130 is positioned relative to either of these data fields, the associated comments would be visible in the secondary visual display 136 instead of the comments 132 associated with data field 122B.

Also illustrated in FIG. 3 are the comments 132 provided by a single party. For example, if the form 120 is an order request form, the comments may be generated by the salesperson indicating a condition to an order term, such as the items would not be available until a certain delivery date. In this embodiment, any comment field indicators 128 would indicate comments provided by the salesperson, by default. Although, in the event that order request is read by the buyer and terms changed, the order request form may become an order form. If the buyer wishes to add comments, the form accommodates multiple user entry comments into the comment field.

FIG. 4 illustrates the embodiment where multiple parties add comments. As discussed below, when comments are added by a user, the identity of the inputting user is included. FIG. 4 illustrates the form 120 having comments 140 provided by two parties, illustrated here as user 1 and user 2. The comments 140 are visible in the display 142 generated based on the positioning of the position indicator 130 relative to the data field 122D. Using the above example that term six 124 is directed to delivery conditions and data six 126 in the data field 122D is directed to a delivery date, comments 1 by the salesperson (user 1) may indicate that an items cannot be shipped for a period of time. A buyer (user 2) upon seeing this condition may enter further comments, comments 2 such as indicating that the buyer is willing to accept an initial delivery amount on a first date and the bulk of the delivery at a later date. The comment field 140, visible in a secondary visual display 142, provides comments by both users in the same field.

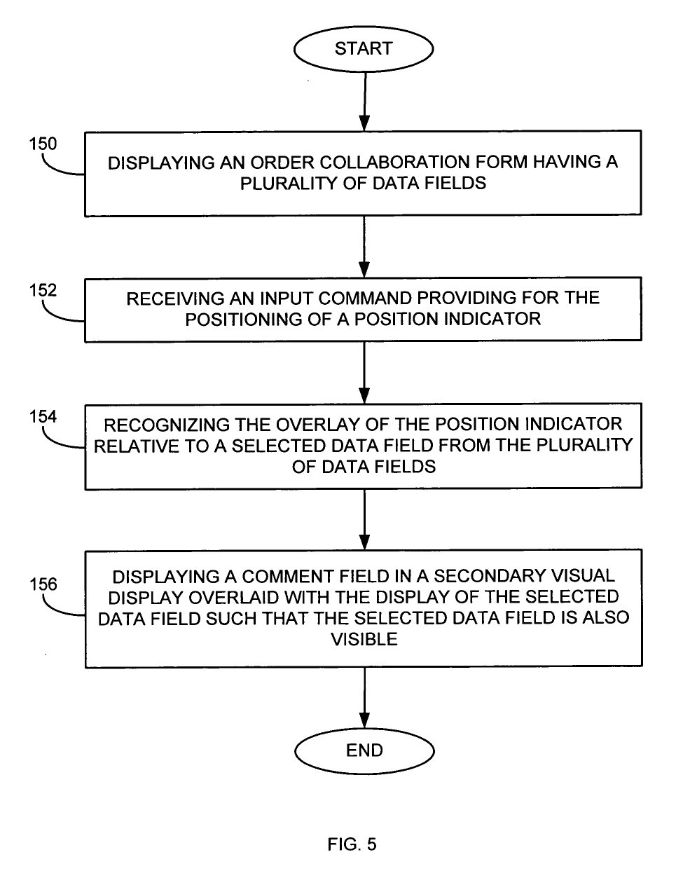

FIG. 5 illustrates a flowchart of the steps of a method for the inclusion of a comment field in an order collaboration form. The method is performed by one or more processing devices, similar to the processing device 104 of FIG. 1 in conjunction with a form database, such as the database 108 of FIG. 1.

The method begins, step 150, by displaying an order collaboration form having a plurality of data fields, with business objects disposed therein. Similar to the illustrated embodiment of FIG. 2, the order collaboration form 110 includes the plurality of data fields 122. The next step is receiving an input command providing for the position of a position indicator, step 152. As illustrated in FIG. 1, an input command 114 is received by the processing device 104 from the input device 102, wherein the position indicator, such as the arrow 130 of FIGS. 2-4, is moved on the display 120.

The next step, step 154, is recognizing the overlay of the position indicator relative to a selected data field from the plurality of data fields. In one embodiment, this step may be performed by known position tracking techniques, as recognized by one having ordinary skill in the art. The next step, step 156, is displaying a comment field in a secondary visual display overlaid with the display of the selected data field such that the selected data field is also visible. As illustrated in a FIG. 3, the secondary visual display 136 is shown in an overlaid position allowing a user to view both the data field, such as field 122B and the comments 132. Thereupon, the method is complete, providing for the inclusion of the comment field 132 in an order collaboration form 120, where the comment field is in an overlaying display, such as illustrated in FIG. 3.

FIG. 5 illustrates the steps of another embodiment of a method for the inclusion of a comment field in an order collaboration form. The method begins, step 160, by retrieving an order collaboration form from a form database and displaying the order collaboration form having a plurality of data fields. Such as illustrated in FIG. 1, the form 110 is retrieved from the form database 108 and displayed on the output device 106. Also, as illustrated in FIG. 2, the form 108 includes a plurality of data fields 122.

The next step, step 162, is receiving an input command providing for the positioning of a position indicator, similar to step 152 of FIG. 4. The next step, step 164, is recognizing the overlay of the position indicator relative to a selected data field from the plurality of data fields, similar to step 154 of FIG. 4. The next step, step 166, is displaying a comment field in a secondary visual display overlaid with the display of the selected data field such that the selected data field is also visible, similar to step 156 of FIG. 4.

The next step, step 168, is receiving a data input command and input data from the input device. With reference to FIG. 1, the data input command 114 may be a keystroke command from a keyboard, a click from a mouse or any other input command. For example, in one embodiment the processing device 104 may recognize a right-mouse-click as indicative of a user wishing to enter comments in a data field, and based on the position of the cursor 130 of FIG. 2, the comment field is associated with the particular data field positioned relative to the position indicator.

The next step, step 170, is inserting the input data into the comment field and associating the input data in the comment field with a user identifier. Using the above example of a right-mouse-click, the user positions the cursor over a data field and depresses a right-mouse-click. The processing device 106 (of FIG. 1) then activates a comment field, such as field 136 of FIG. 3. In the event there are no existing comments, a blank field is generated and displayed, otherwise the new comments are added to the existing comments and delineated based on user identifiers.

Once the user begins entering comments, such as typing keystrokes into a keyboard, the comments are inserted into the comment field in accordance with standard data entry techniques. Various embodiments may be utilized to associate the comments with a particular user, such as using a particular font or a designated color, or in another embodiment, using a precursor to the comments indicating the user's identity, such as illustrated in FIG. 4. While visually, the user input is being displayed in the comment field, the processor stores the comments in a secondary comment field associated with the form. For example, a designated data field may be encoded with the form such that processor understands the data in the field is associated with a data-field specific comment field.

The next step, step 172, is storing the input data with the order collaboration form in the form database. Such as illustrated in FIG. 1, the input data and order collaboration form 116 is stored in the database 108. As discussed above, the form includes encoded data fields with associated information and the input data includes the additional comment data received from the user input associated with the data fields of the form.

The next step, step 174, is providing the input data and the order collaboration form to an intended recipient using an output device. As discussed above, the form database 108 is a general database accessible by multiple parties, such as a supplier relationship management database with order collaboration forms. In this embodiment, multiple users from multiple access points utilize this database 108 for various business operations. For example, a buyer may, through a web-based access point, enter the database 108 to retrieve purchase order requests, with data fields having the comments associated therewith. The database 108, in accordance with known database techniques, is operative to provide the input data and the order collaboration form to the buyer, when the buyer accesses the database and retrieves the document. It is also recognized that the seller may access the database 108 to retrieve the purchase order, where the purchase order includes the purchase order request approved or modified by the buyer. In following the above embodiment, either party may access and retrieve the document in its various forms and not only see the other party's comments, but also add additional comments thereto. As such, both parties can provide a direct interactive dialogue in the comment field directly associated with the specific and proper terms. As such, one embodiment of this method is complete.

It is recognized that there exists further modification available within the scope of this apparatus and method. For example, when multiple users add comments, security may be provided to restrict who is able to view the comments. Furthermore, this viewing restriction may include restricting notification of comments through the display of the comment field indicator 128. For example, when a first user enters comments, the security may be restricted to a class of users, such as a seller may restrict the viewing of comments to the seller's fellow employees or supervisors. The security may be set using known security operations of verifying the user's identity prior to displaying either the indicator or the comments themselves. In the above example, a salesman may include comments for a supervisor regarding issues of an order, but if the buyer accesses the order request form, the comments are invisible to the buyer.

Therefore, there is provided a direct comment field associated with a data term. The comment field is visible when a position indicator is relative to the data field and the presence of the comment field is indicated by an indicator. The user may then readily see additional comments provided in conjunction with terms in the electronic form, where the comments are directly associated with the fields. Users may also directly enter comments associated with data field, adding new comments to data fields or adding comments to existing comment fields. Regardless thereof, comments are now readily visible in electronic forms, overcoming the previous limitations of all comments being allocated to a general comment field, which may be easily overlooked or misinterpreted by another user.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for the inclusion of a comment field in an order collaboration form, the apparatus comprising:
a form database having stored therein the order collaboration form and business objects associated therewith; and
a processing device, in response to executable instructions, operative to:
display the order collaboration form from the form database having business objects disposed in data fields;
receive an input command providing for the positioning of a position indicator;
recognize an overlay of the position indicator relative to a selected data field in the order collaboration form; and
display the comment field in a secondary visual display overlaid with the display of the selected data field such that the selected data field is also visible.

2. The apparatus of claim 1 further comprising:
a display device coupled to the processing device such that the display of order collaboration form and the comment fields are displayed thereon.

3. The apparatus of claim 1 wherein the secondary visual display is a pop-up window.

4. The apparatus of claim 1 further comprising:
an input device coupled to the processing device such that the input device receives the input command and provides the input command to the processing device.

5. The apparatus of claim 4 wherein the input command includes commands associated with moving the position indicator.

6. The apparatus of claim 4 further comprising:
the processing device, in response to executable instructions, operative to:
receive a data input command from the input device;
receive input data from the input device; and
insert the input data into the comment field.

7. The apparatus of claim 6, the processing device further operative to: associate the input data in the comment field with a user identifier.

8. The apparatus of claim 7, the processing device further operative to:
store the input data with the order collaboration form in the form database.

9. The apparatus of claim 7 further comprising:
an output device coupled to the processing device, the processing device operative to, in response to executable instructions:
provide the input data and the order collaboration form to the output device for providing the order collaboration form with input data to an intended recipient.

10. The apparatus of claim 1, the form database is a supplier relationship management database having one or more of the order collaboration forms stored therein.

11. A method for the inclusion of a comment field in an order collaboration form, the method comprising:
displaying an order collaboration form having business objects disposed in a plurality of data fields;
receiving an input command providing for the positioning of a position indicator;
recognizing the overlay of the position indicator relative to a selected data field from the plurality of data fields;
displaying a comment field in a secondary visual display overlaid with the display of the selected data field such that the selected data field is also visible, wherein the content of the comment field is from the business object displayed in the data field.

12. The method of claim 11 further comprising the secondary visual display is a pop-up window.

13. The method of claim 11 further comprising:
receiving a data input command from an input device;
receiving input data from the input device; and
inserting the input data into the comment field.

14. The method of claim 13 further comprising:
associating the input data in the comment field with a user identifier.

15. The method of claim 14 further comprising:
storing the input data with the order collaboration form in a form database.

16. The method of claim 11 further comprising:
providing the input data and the order collaboration form to an intended recipient using an output device.

17. The method of claim 11 wherein the order collaboration form and the business objects are received from a form database.

18. The method of claim 17 wherein the form database is a supplier relationship management database.

19. An apparatus for the inclusion of a comment field in an order collaboration form, the apparatus comprising:
an input device;
a display device;
a form database having stored therein the order collaboration form and a plurality of business objects; and
a processing device in operative communication with the input device, the display device and the form database, in response to executable instructions, the processing device operative to:
display the order collaboration form from the form database having the business objects associated therewith;
receive an input command from the input device, the input command providing for the positioning of a position indicator;
recognize an overlay of the position indicator relative to a selected data field from a plurality of data fields in the selected order collaboration form;
receive a data input command from the input device;
receive input data from the input device;
insert the input data into the comment field; and
display the comment field in a secondary visual display overlaid with the display of the selected data field such that the selected data field is also visible on the display device.

20. The apparatus of claim 19, the processing device further operative to:
associate the input data in the comment field with a user identifier; and
store the input data with the order collaboration form in the business object in the form database.

21. The apparatus of claim 19 further comprising:
an output device coupled to the processing device, the processing device operative to, in response to executable instructions:
provide the input data and the order collaboration form to the output device for providing the order collaboration form with input data to an intended recipient.

22. The apparatus of claim 19, the form database is a supply relations management database having one or more of the order collaboration forms stored therein.
